(19) United States
(12) Patent Application Publication
(10) Pub. No.: US 2009/0152413 A1
(43) Pub. Date: Jun. 18, 2009

(54) MULTI-LEGGED SUPPORT ASSEMBLY FOR MUSICAL INSTRUMENTS AND THE LIKE

(76) Inventor: Akito TAKEGAWA, Chiba (JP)

Correspondence Address: BERENATO, WHITE & STAVISH, LLC, 6550 ROCK SPRING DRIVE, SUITE 240, BETHESDA, MD, 20817, US

(21) Appl. No.: 11/954,287

(22) Filed: Dec. 12, 2007

(51) Int. Cl. F16M 11/38

(52) U.S. Cl. 248/170

(57) ABSTRACT

A musical instrument stand comprises a main post and a plurality of legs having respective proximate ends adjacent the main post and distal ends opposite the proximate ends. A holding member is disposed on the proximate ends of the legs and movable along the main post. Respective articulated arms are hingedly connected to the legs intermediate the proximate and distal ends of the legs, and the respective articulated arms are further hingedly connected to the main post through a movable holding member. The holding members, the legs, and the articulated arms define a modular assembly that is removable from said main post as a unitary body, wherein the modular assembly is capable of being configured in a first angled support arrangement and a second flat support arrangement to place the leg flush on the support surface.

### BACKGROUND OF THE INVENTION

1. Field of the Invention

The present invention relates to a tripod stand, particularly suited for musical instruments, wherein the stand has a main post and a tripod leg structure supporting the main post.

2. Description of the Related Art

Musical instruments such as drum kits consisting of sets of drums and cymbals use various types of stands supported by a tripod structure.

The tripod structure is collapsible, wherein the legs of the stand may be folded inward toward the main post and may be extended, folded or tilted outward, to form a tripod or three leg support structure.

Conventional tripod stands, e.g. for supporting musical instruments or other devices, include a main post and three legs supporting the post. A sliding structure is provided at the main post to enable the three legs to be folded outward from the main post to a supporting position and inward toward the main post to a storage or carrying position. The sliding structure may comprise an upper holding member slidable along the main post. The upper end of each leg of the tripod stand is journaled or hingedly connected to the upper holding member. In such cases, the outer end of a respective articulated arm is journaled or hingedly connected along each leg, generally approximately at the middle of the leg and usually at the same distance along each leg from the upper holding member. A typically stationary, non-slidable lower holding member is provided on the main post below the upper holding member. The other, inner end of each articulated arm is journaled or hingedly connected to the stationary lower holding member. The above described movement of the tripod legs from the outward supporting to the inward storage positions can be achieved by the upper holding member being slidable along the main post while the lower holding member is stationary. With these types of connection for the legs and the articulated arms of the stand, the sliding of the slidable holding member along the main post determines the angles, measured through the main post, at which the legs are separated from each other and from the main post. Depending on the angle of the legs, it may be difficult to closely arrange different instruments and other equipment around the convention tripod stand.

The need exists for a multi-legged stand having foldable or collapsible legs that provide a more versatile arrangement whereby the space around the stand can be maximized in some environments by lowering the legs down to the ground while the stand alternatively may be placed in the more conventional angled arrangement when needed.

### SUMMARY OF THE INVENTION

A musical instrument stand comprises a main post and a plurality of legs having respective proximate ends adjacent the main post and distal ends opposite the proximate ends. A holding member is hinged to the proximate ends of the legs and movable along the main post. Respective articulated arms are hinged to the legs intermediate the proximate and distal ends of the legs, and the respective articulated arms are further hinged to the main post through a movable holding member. The holding members, the legs, and the articulated arms define a modular assembly that is removable from said main post as a unitary body, wherein the modular assembly is capable of being configured in a first angled (e.g., conventional tripod) support arrangement and a second flat (e.g., legs flush to the ground) support arrangement to place the leg flush on the support surface.

### BRIEF DESCRIPTION OF THE DRAWINGS

These and other objects, aspects and embodiments of the present invention will be described in more detail with reference to the following drawing figures, of which:

FIG. 1 is an exploded perspective view of a tripod assembly and main post;

FIG. 2 is a perspective view of the tripod assembly shown in FIG. 1 shown the tripod in the first angled support arrangement;

FIG. 3 is an enlarged partial view of the main post and upper and lower holding members disposed on the main post;

FIG. 4 is a perspective view of the tripod assembly shown in FIG. 1 shown the tripod in the second flat support arrangement;

FIG. 5 is a plan view of the tripod assembly shown in FIG. 4 in the second flat support arrangement;

FIGS. 6-9 are schematic illustrations for the step-by-step process of converting the stand from the flat support arrangement to the angled support arrangement.

### DESCRIPTION OF THE PREFERRED EMBODIMENTS

This invention will be described in further detail by way of examples with reference to the accompanying drawings.

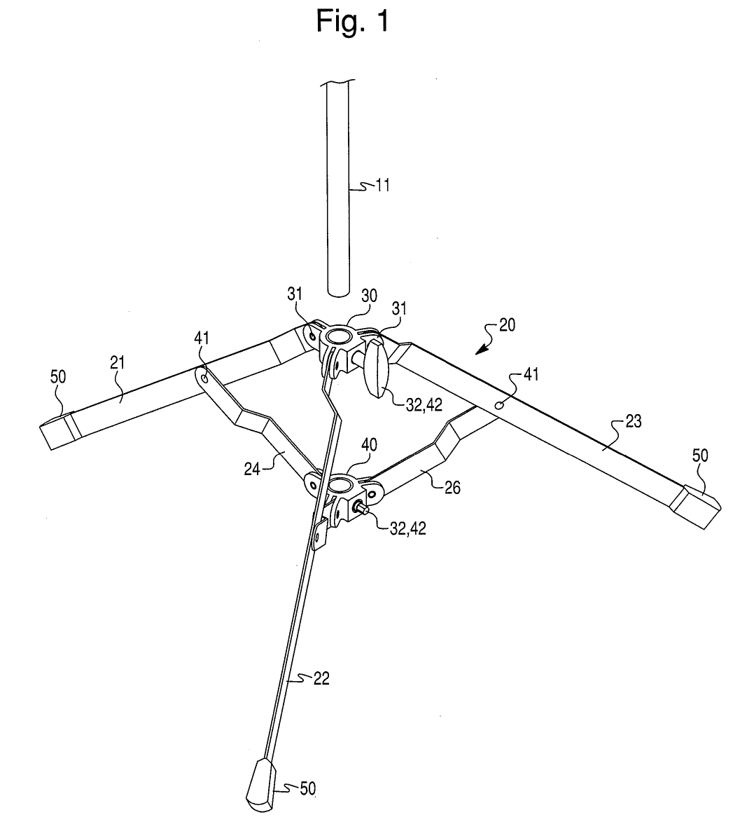

The tripod stand for musical instruments or other objects illustrated in FIG. 1 comprises a main post 11 and a three leg tripod part 20 located at the lower end of the main post 11. The main post 11 may be provided with any desired adjustable elongation or extension, not illustrated, and any connection or holder for engaging a particular musical instrument or another device, such as a microphone. While a three-legged tripod is illustrated by the figures, it will be understood by those of skill in the art that any number of legs may be provided without departing from the spirit and scope of this invention.

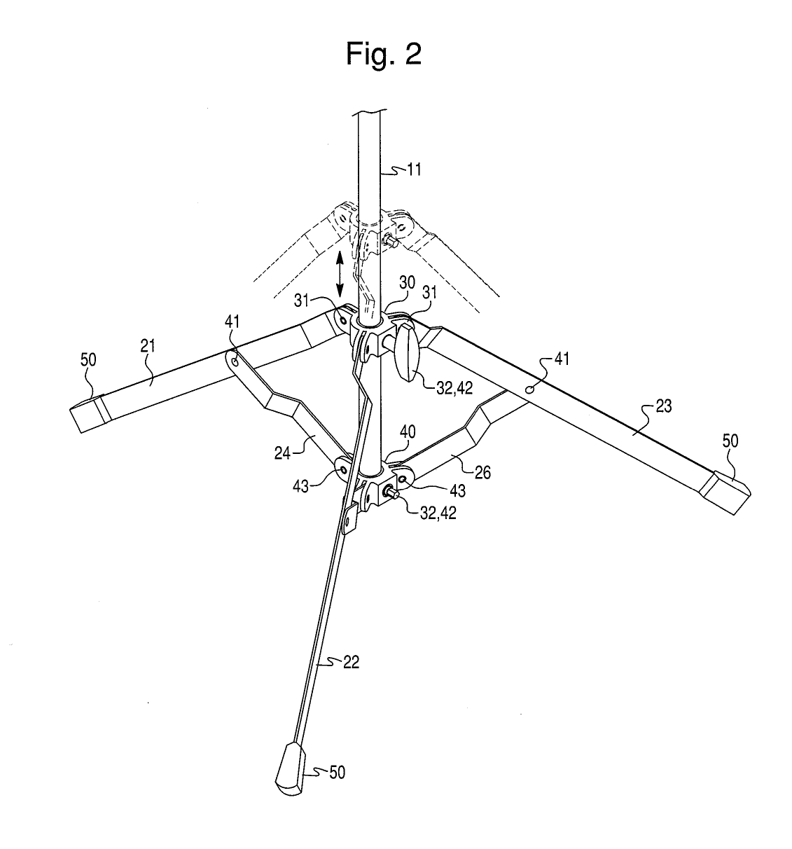

As can be better understood from FIG. 2, the tripod section 20 includes the three legs 21, 22 and 23 and the articulated arms 24, 25 and 26, which are each hingedly connected or journaled at respective hinge pins 41 to the respective legs 21, 22 and 23 at a location along each leg intermediate its ends, preferably at its midpoint between the upper and bottom ends of the leg.

An upper, leg holding member 30 is slidable along the main post 11 and may be set at any desired position along the main post 11 by the set screw or wing nut 32. The upper end of each leg 21, 22 and 23 is also hingedly, pivotally connected at respective hinge pins 31 to the upper holding member 30. As shown in FIG. 2, the position of the upper leg holding member 30 alters the angular position of each leg 21, 22, 23 with respect to the main post 11.

A lower holding member 40 is placed on the main post, spaced below the upper holding member 30, and is preferably at the terminal or bottom end of the main post 11. The lower holding member 40 may be set at any desired position along the main post 11 by the set screw or wing nut 42. The lower end of each articulated arm 24, 25 and 26 is hingedly, pivotally connected on the lower holding member 40 by a respective hinge pin 43.

In the preferred embodiment, a resilient foot member 50 is provided at the terminal end of each leg 21, 22, 23 in order to resiliently support and cushion the tripod assembly on a floor or other substrate.

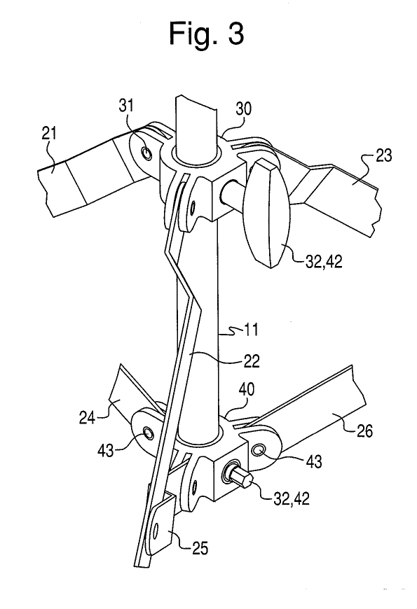

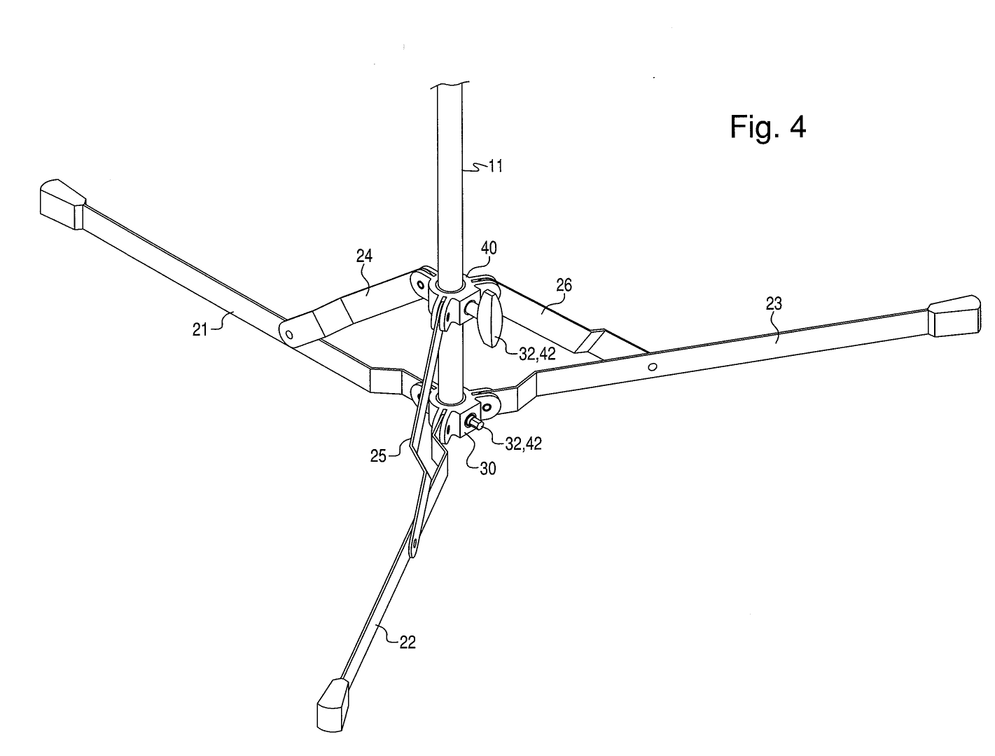

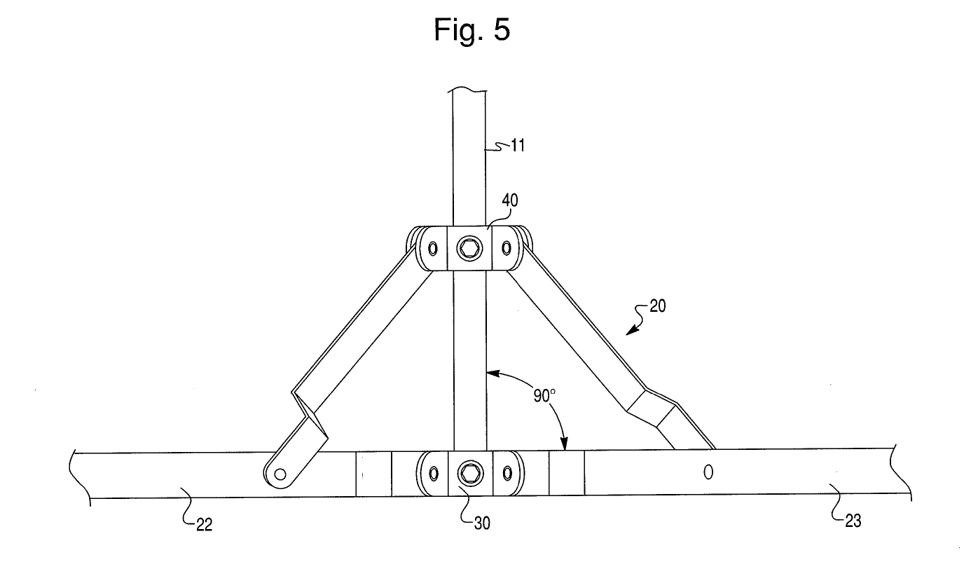

Turning now to FIGS. 4 and 5, the primary benefit provided by this invention will now be described. In accordance with the invention, the tripod part 20 is a modular assembly that may be selectively removed from the main post 11, then inverted to convert the assembly from the first angled support arrangement shown in FIGS. 1-3 to the second flat support arrangement shown in FIGS. 4 and 5. Specifically, the set screws 32, 42 (or other suitable fasteners) are loosened to permit the upper and lower holding members 30, 40 of the modular tripod part 20 to slide off the main post 11. Then, the modular tripod part 20 is inverted so that the holding member 40 is placed on the main post 11 before the holding member 30. The holding member 30 is then fixed at the terminal end of the main post 11 so as to be flush with the terminal end of the main post 11 (see FIG. 5). In the second flat support arrangement shown in FIG. 5, the legs 21, 22, 23 are disposed substantially at an angle of 90 degrees with respect to the main post 11.

It is further noted that the legs 21, 22, 23 and articulated arms 24, 25, 26 may be formed with a bent portion to increase the stability and support provided by the stand in either the flat or angled support arrangement. Other types of stabilizing features may also be added to the legs of the tripod part 20 to enhance stability and strength of the stand.

The structural arrangement of the present invention provides a versatility that is not available in conventional tripod stands known in the music industry. For example, the flat support embodiment allows the legs to be placed under instruments, such as bass drums, to allow close placement of the stand relative to the instrument. The tripod or angled support embodiment allows better stability of the stand in situations requiring more stability, such as, playing outdoors in a cross wind.

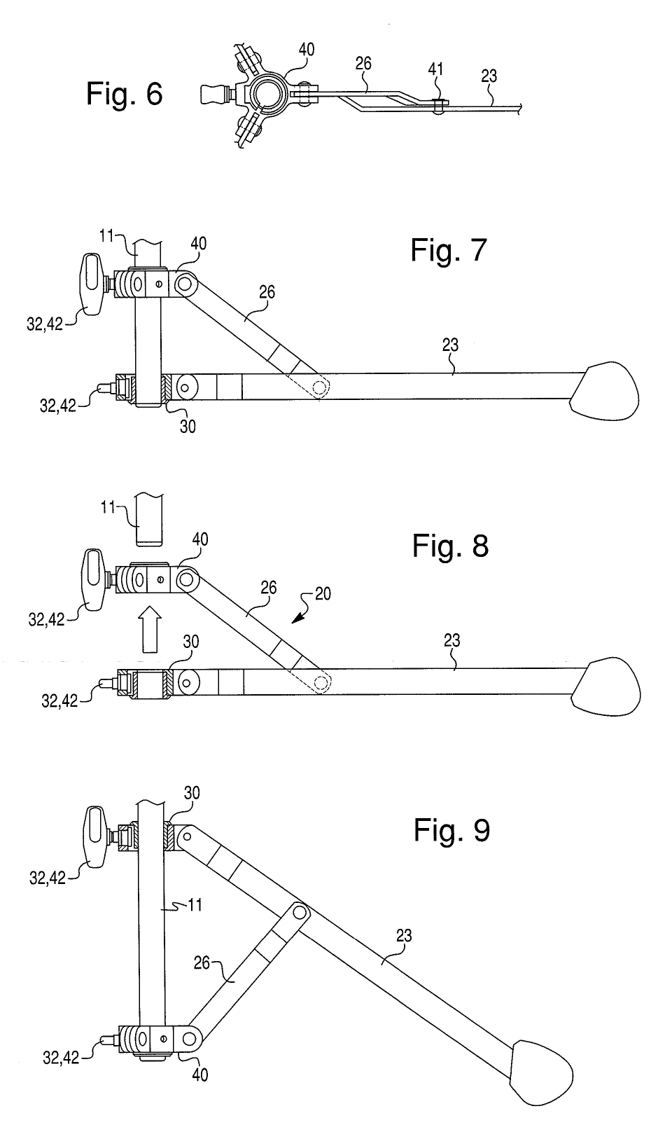

FIGS. 6-9 illustrate in schematic manner the process for converting the stand from the flat support arrangement to the angled support arrangement. FIG. 6 is a schematic showing a portion of the tripod part 20 and main post 11 from the top view. FIG. 7 shows the tripod part 20 and main post 11 of FIG. 6 from a plan or side view showing the leg 23 at a substantial angle of 90 degrees with respect to the main post 11 to provide the flat support embodiment where the legs 21, 22, 23 are substantially flush with the ground or other substrate. FIG. 8 shows that, after the set screw 32 and wing bolt 42 are loosened, the modular tripod part 20 is removed from the main post 11. FIG. 9 lastly shows that the modular tripod part 20 is inverted and placed on the main post 11 in the inverted position to provide a more conventional angled support embodiment for the stand.

Although the present invention has been described in connection with a plurality of preferred embodiments thereof, many other variations and modifications will be apparent to those skilled in the art. It is preferred, therefore, that the present invention be limited not by the specific disclosure herein, but only by the appended claims.

1. A multi-legged stand for a musical instrument, comprising:
a main post;
a plurality of legs having respective proximate ends adjacent the main post and distal ends opposite said proximate ends;
a first holding member hinged to the proximate ends of the legs and selectively movable along the main post for moving the proximate ends of the legs along the main post;
respective articulated arms hinged to the legs intermediate the proximate and distal ends of the legs, said respective articulated arms further hinged to the main post through a second holding member that is selectively movable along the main post,
wherein movement of the first and second holding members with respect to the main post, through the articulated arms, selectively folds the legs together to close the stand and opens the legs apart to a supporting condition by forming the lower ends of the legs to support the multi-legged stand.

2. The multi-legged stand according to claim 1, wherein each of the first and second holding members is fixedly secured to the main post via respective set screws to permit movement of both the first and second holding members along the main post.

3. The multi-legged stand according to claim 1, wherein said holding members, said plurality of legs, and said articulated arms define a modular assembly that is removable from said main post as a unitary body, said modular assembly capable of being configured in a first angled support arrangement and a second flat support arrangement by inverting said modular assembly.

4. The multi-legged stand according to claim 3, wherein said first angled support arrangement is provided by arranging said first holding member along a length of said main post and by arranging said second holding member at a terminal end of said main post.

5. The multi-legged stand according to claim 3, wherein said second flat support arrangement is provided by arranging said second holding member along a length of said main post and by arranging said first holding member at a terminal end of said main post.

6. The multi-legged stand according to claim 3, wherein said plurality of legs are disposed at substantially a right angle to said main post when configured as said second flat support arrangement.

7. The multi-legged stand according to claim 3, wherein said first holding member is substantially flush with the terminal end of said main post when arranged in said second flat support arrangement.

8. The multi-legged stand according to claim 1, wherein said main post passes through at least one of said first and second holding members.

9. The multi-legged stand according to claim 1, wherein at least one of said holding members is circular.

10. A method of arranging a multi-legged stand for a musical instrument, comprising the steps of:
providing a main post;
providing an assembly comprising,
a plurality of legs having respective proximate ends and distal ends opposite said proximate ends;
a first holding member hinged to the proximate ends of the legs; and
respective articulated arms hinged to the legs intermediate the proximate and distal ends of the legs, said respective articulated arms further hinged to a second holding member,
selectively affixing said assembly to said main post by affixing said first and second holding member to said main post in one of a first angled support arrangement and a second flat support arrangement by inverting said modular assembly relative to said main post.

11. The method according to claim 10, wherein said assembly is a modular assembly provided as a unitary assembly of elements.

12. The method according to claim 10, wherein said step of selectively affixing in said first angled support arrangement comprises arranging said first holding member along a length of said main post and by arranging said second holding member at a terminal end of said main post, and said step of selectively affixing in said second flat support arrangement comprises arranging said second holding member along a length of said main post and by arranging said first holding member at a terminal end of said main post.

13. The method according to claim 10, wherein movement of the first and second holding members with respect to the main post, through the articulated arms, selectively folds the legs together to close the stand and opens the legs apart to a supporting condition by forming the lower ends of the legs to support the multi-legged stand.

14. The method according to claim 10, further comprising the step of disposing said plurality of legs at substantially a right angle to said main post.

15. The method according to claim 10, further comprising the step of disposing said first holding member substantially flush with the terminal end of said main post when arranged in said second flat support arrangement.

16. The method according to claim 10, further comprising the step of selectively securing each of the first and second holding members to the main post via respective set screws to permit movement of both the first and second holding members along the main post.
